(19) United States
(12) Patent Application Publication
(10) Pub. No.: US 2012/0026454 A1
(43) Pub. Date: Feb. 2, 2012

(54) Eyeglass Auxiliary Device

(76) Inventor: Ching-Yung Wu, Tainan City (TW)

(21) Appl. No.: 13/052,298

(22) Filed: Mar. 21, 2011

(30) Foreign Application Priority Data
Aug. 2, 2010 (TW) 099214753

(51) Int. Cl. G02C 11/00

(52) U.S. Cl. 351/158

(57) ABSTRACT

An eyeglass auxiliary device detachably connects an earplug and an eyeglass device, and includes: a clamp unit including a base plate having first and second opposite sides, and a pressing plate that has a hinged end portion hinged to the base plate at the first side, an engaging end portion disposed opposite to the hinged end portion and detachably engaging the base plate at the first side, and a clamp portion disposed between the hinged end portion and the engaging end portion and adapted for clamping the earplug; and a temple-connected unit connecting to the base plate at the second side and adapted for mounting on a temple of the eyeglass device.

### CROSS-REFERENCE TO RELATED APPLICATION

This application claims priority of Taiwanese application no. 099214753, filed on Aug. 2, 2010.

### BACKGROUND OF THE INVENTION

1. Field of the Invention

This invention relates to an eyeglass auxiliary device, more particularly to an eyeglass auxiliary device for detachably connecting an earplug to an eyeglass device.

2. Description of the Related Art

When working in a harsh environment where noise, strong light, splashed residues, etc., exist, it is necessary for workers to wear personal protective accessories such as eyeglasses and earplugs so as to ensure working safety. Generally, the protective accessories are separate from each other so that workers have to wear, take off, or store them individually. It is troublesome and time-consuming for workers to cope with the separate protective accessories. Moreover, the separate protective accessories are easily misplaced.

Taiwanese Patent no. M259174 discloses a glasses auxiliary outfit that is mounted on a temple of a pair of glasses and that may hold a cord of earplugs so as to connect the earplugs to the glasses. The applicant of the present invention desires to provide an eyeglass auxiliary device for easily detachably connecting an earplug to an eyeglass device.

### SUMMARY OF THE INVENTION

According to the present invention, an eyeglass auxiliary device is suitable for detachably connecting an earplug to an eyeglass device, and comprises: a clamp unit including a base plate having first and second opposite sides, and a pressing plate that has a hinged end portion hinged to the base plate at the first side, an engaging end portion disposed opposite to the hinged end portion and detachably engaging the base plate at the first side, and a clamp portion disposed between the hinged end portion and the engaging end portion and adapted for clamping the earplug; and a temple-connecting unit connected to the base plate at the second side and adapted for mounting on a temple of the eyeglass device.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of the first preferred embodiment of an eyeglass auxiliary device according to this invention viewed from a temple-connecting unit thereof;

FIG. 2 is a perspective view of the first preferred embodiment viewed from a clamp unit thereof;

FIG. 3 is a fragmentary perspective view showing a pair of the first preferred embodiment of the eyeglass auxiliary devices which connects a pair of earplugs to an eyeglass device;

FIG. 4 is a perspective view of the second preferred embodiment of an eyeglass auxiliary device according to this invention;

FIG. 5 is a side view of the second preferred embodiment;

FIG. 6 is a fragmentary perspective view showing connection among the second preferred embodiment of the eyeglass auxiliary device, an earplug, and a temple of an eyeglass device; and

FIG. 7 is a sectional view of the second preferred embodiment shown in FIG. 6.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

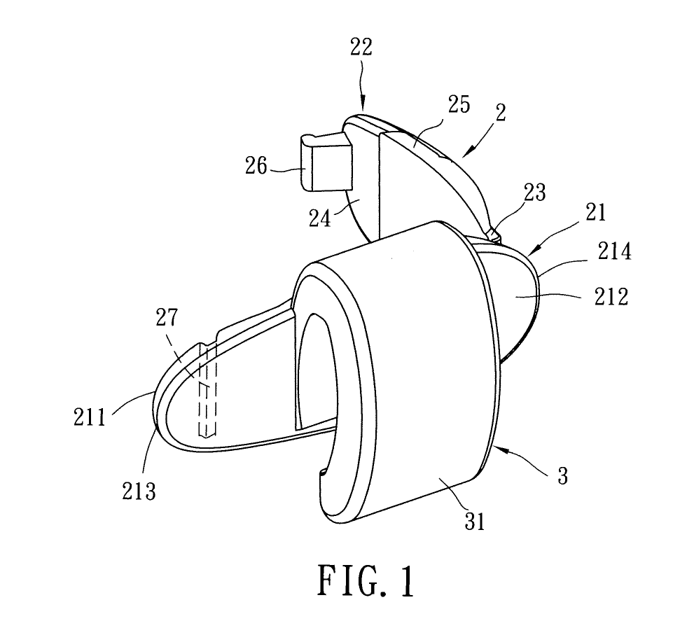

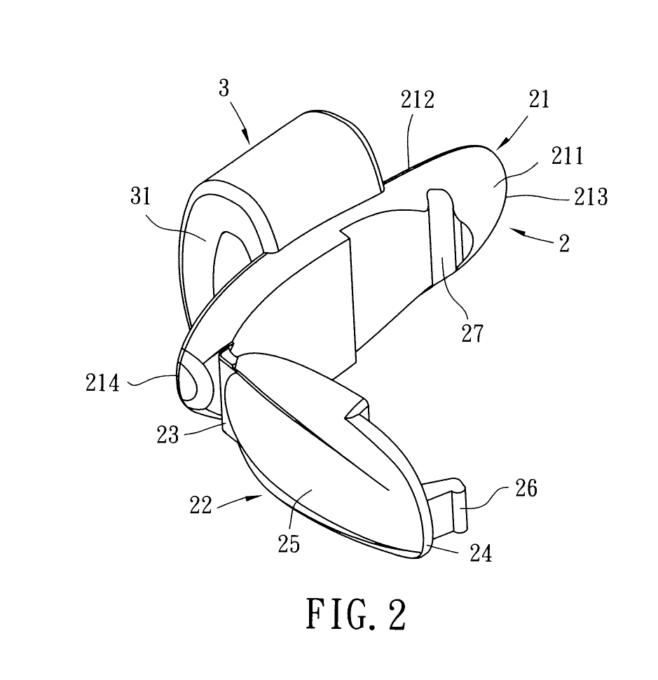

Referring to FIGS. 1 and 2, the first preferred embodiment of an eyeglass auxiliary device according to this invention comprises a clamp unit 2 and a temple-connecting unit 3. The clamp unit 2 includes: a base plate 21 having first and second opposite sides 211, 212 and front and rear ends 213, 214; and a pressing plate 22 that has a hinged end portion 23 hinged to the base plate 21 at the first side 211 and the rear end 214, an engaging end portion 24 disposed opposite to the hinged end portion 23 and detachably engaging the base plate 21 at the first side 211 and the front end 213, and a clamp portion 25 disposed between the hinged end portion 23 and the engaging end portion 24 and adapted for clamping an earplug against the base plate 21.

In this embodiment, the clamp unit 2 further comprises interlocking elements which include an engaging hook 26 and an engaging groove 27. The engaging groove 27 is disposed on the first side 211 at the front end 213 of the base plate 21, and the engaging hook 26 is formed on the engaging end portion 24 of the pressing plate 22. The locations of the engaging hook 26 and the engaging groove 27 are interchangeable.

It should be noted that the hinged end portion 23 of the pressing plate 22 may be alternatively hinged to the base plate 21 at the front end 213, and the engaging end portion 24 may detachably engage the base plate 21 at the rear end 214. Accordingly, one of the interlocking elements 26, 27 of the clamping unit 2 may be disposed at the rear end 214 of the base plate 21.

Preferably, the pressing plate 22 and the base plate 21 of the clamp unit 2 are integrally formed and connected to each other through the hinged end portion 23 of the pressing plate 22.

The temple-connecting unit 3 is connected to the base plate 21 of the clamp unit 2 at the second side 212 and adapted for mounting on a temple of an eyeglass device. Particularly, in this preferred embodiment, the temple-connecting unit 3 includes a hook 31 for anchoring on a temple of an eyeglass device.

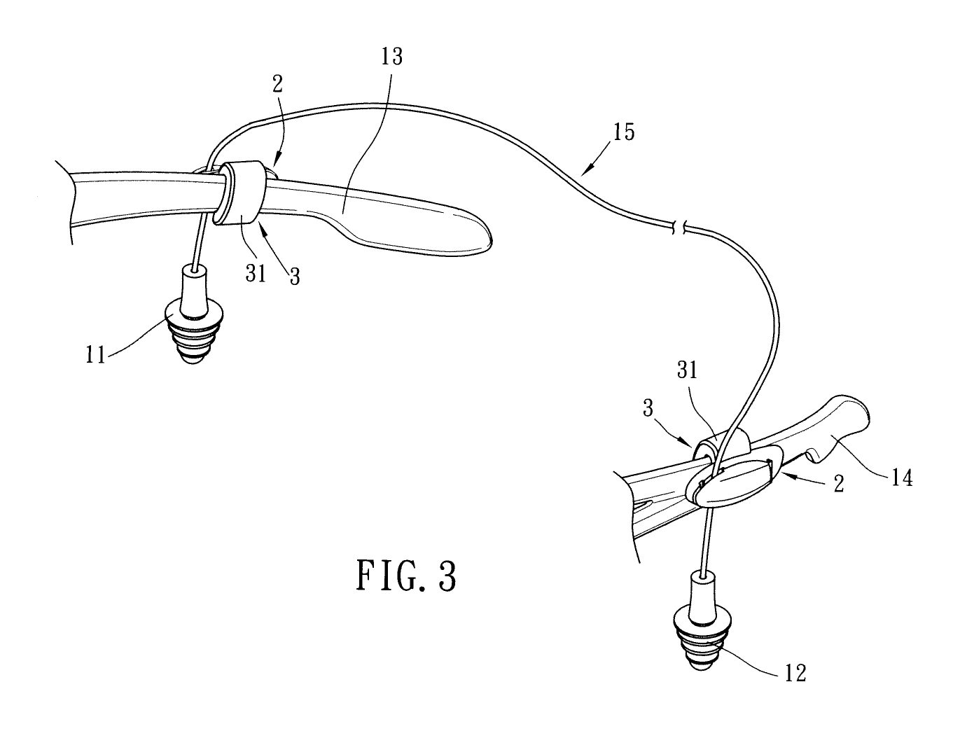

FIG. 3 shows a pair of the first preferred embodiment of the eyeglass auxiliary devices which detachably connect a pair of earplugs 11, 12 to temples 13, 14 of an eyeglass device. The eyeglass device can be nearsighted eyeglasses, sunglasses, safety eyeglasses, or any other optical eyeglasses. The earplugs 11, 12 are connected to each other using a cord 15.

In use, the hook 31 of the temple-connecting unit 3 of the eyeglass auxiliary device is anchored on one of the temples 13, 14 of the eyeglass device. The cord 15 that interconnects the earplugs 11, 12 is disposed between the clamp portion 25 of the clamp unit 2 and the base plate 21, followed by engaging the interlocking elements 26, 27, thereby firmly clamping the cord 15 and connecting the eyeglass device and the earplugs 11, 12. As a result, when a user wears the eyeglass device, the earplugs 11, 12 are disposed near the user's ears so that it is convenient for the user to use the earplugs 11, 12. Moreover, if the cord 15 is disposed behind the user's neck, the eyeglass device and the earplugs 11, 12 could be hung on the neck when the eyeglass device and the earplugs 11, 12 are taken off. The problem of misplacing the earplugs 11, 12 can be alleviated.

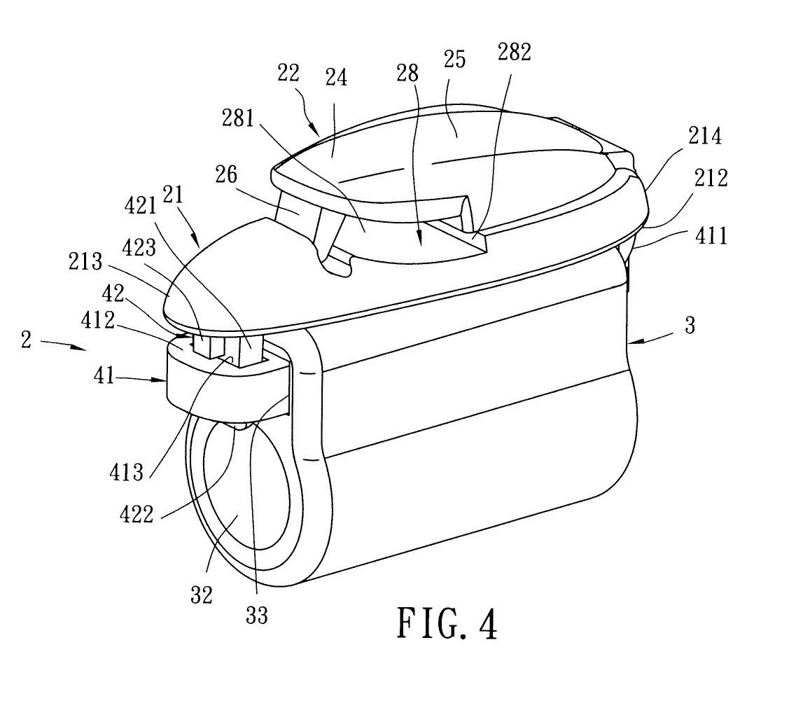

Referring to FIGS. 4 to 7, the second preferred embodiment of an eye-glass auxiliary device according to this invention differs from the first preferred embodiment in that the clamp unit 2 further includes a coupling plate 41 and an engaging pin 42, and the temple-connecting unit 3 includes a connecting body that replaces the hook 31 of the first preferred embodiment and that is connected to the coupling plate 41 of the clamp unit 2.

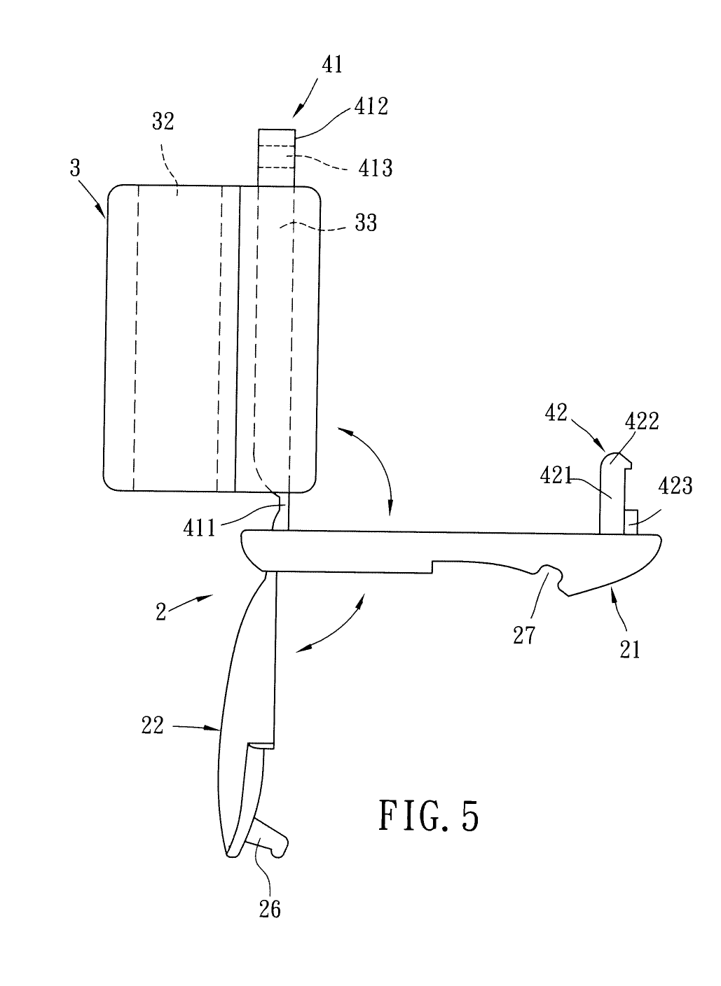

In this embodiment, the coupling plate 41 of the clamp unit 2 has a first end 411 hinged to the base plate 21 at the second side 212 and the rear end 214, and a second end 412 opposite to the first end 411 and formed with a pin-extension hole 413. Preferably, the first end 411 of the coupling plate 41 is pivotally connected to the base plate 21 such that the coupling plate 41 may be swung relative to the base plate 21 as shown in FIG. 5. The engaging pin 42 of the clamp unit 2 projects from the second side 212 at the front end 213 of the base plate 21 to interlock with the pin-extension hole 413 of the coupling plate 41, and includes a leg portion 421 connected to the base plate 21 and a barbed end 422 connected to the leg portion 421 oppositely of the base plate 21. It should be noted that the barbed end 422 has a dimension larger than the pin-extension hole 413 such that, when the engaging pin 42 passes through the pin-extension hole 413 so as to expose the barbed end 422 from the pin-extension hole 413, the engaging pin 42 can firmly interlock with the pin-extension hole 413. Preferably, the leg portion 421 includes a shoulder part 423 proximate to the base plate 21 for abutting against the coupling plate 41 near the pin-extension hole 413 when the engaging pin 42 interlocks with the pin-extension hole 413.

The connecting body of the temple-connecting unit 3 is formed with a first through hole 32 adapted to receive a temple of an eyeglass device, and a second through hole 33. The coupling plate 41 of the clamp unit 2 detachably extends into the second through hole 33 such that the pin-extension hole 413 of the coupling plate 41 is exposed from the connecting body. The temple-connecting unit 3 may be produced to have the first through hole 32 with different dimensions depending on requirements. The coupling plate 41 of the clamp unit 2 can be coupled to the different temple-connecting units 3 for use with temples of different eyeglass devices. Preferably, the temple-connecting unit 3 is made from silica gel or any other flexible material.

It should be noted that, in this preferred embodiment, the clamp portion 25 of the pressing plate 22 cooperates with the base plate 21 to define a clamp space 28 that includes a wide space portion 281 adjacent to the engaging end portion 24 and a narrow space portion 282 adjacent to the wide space portion 281.

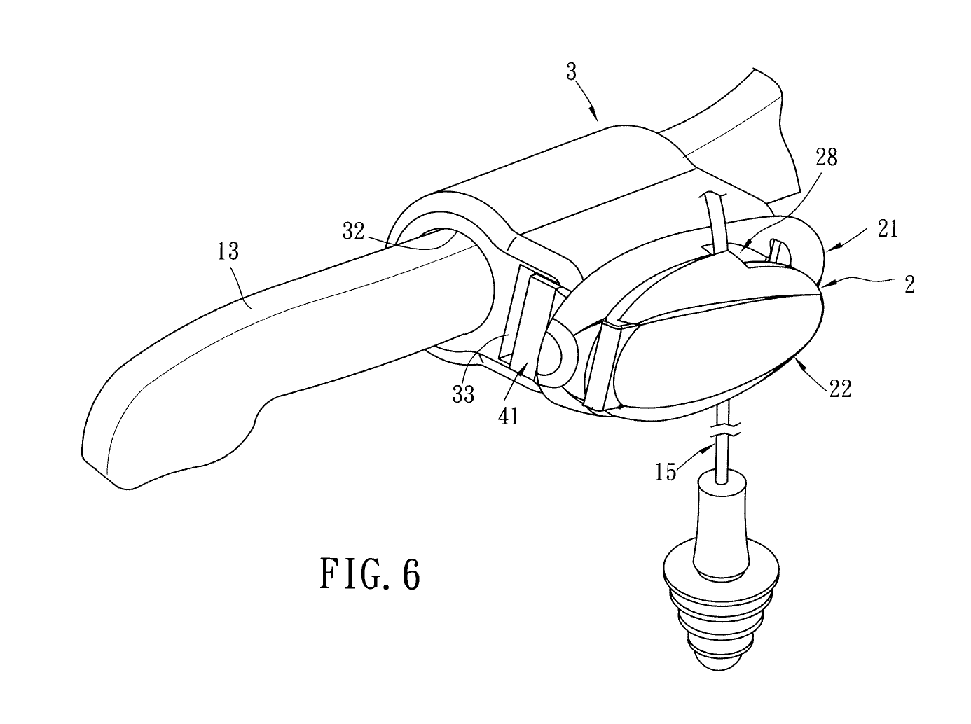

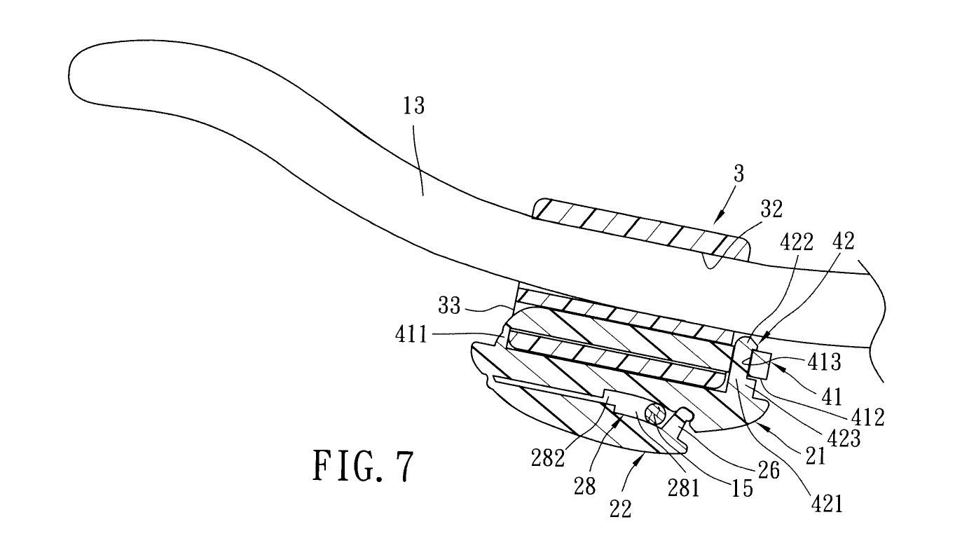

FIGS. 6 and 7 show the connections among the second preferred embodiment of the eyeglass auxiliary device of the present invention, an earplug, and a temple 13 of an eyeglass device. Likewise, the earplug is attached to a cord 15 so as to connect to another earplug (not shown). The cord 15 is disposed in the wide space portion 281 of the clamp space 28. By engaging the interlocking elements 26, 27, the cord 15 is firmly clamped between the base plate 21 and the pressing plate 22 such that the earplug is connected to the eyeglass device and is convenient to use.

Through the eyeglass auxiliary device of the present invention, an earplug is detachably connected to an eyeglass device easily and conveniently such that the eyeglass device and the earplug become user-friendly. The eyeglass auxiliary device maybe designed to conform to the temples of various eyeglass devices.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. An eyeglass auxiliary device for detachably connecting an earplug to an eyeglass device, comprising:
a clamp unit including a base plate having first and second opposite sides, and a pressing plate that has a hinged end portion hinged to said base plate at said first side, an engaging end portion disposed opposite to said hinged end portion and detachably engaging said base plate at said first side, and a clamp portion disposed between said hinged end portion and said engaging end portion and adapted for clamping the earplug; and
a temple-connecting unit connected to said base plate at said second side and adapted for mounting on a temple of the eyeglass device.

2. The eyeglass auxiliary device of claim 1, wherein said clamp unit further includes interlocking elements disposed respectively on said base plate and said engaging end portion of said pressing plate.

3. The eyeglass auxiliary device of claim 2, wherein said interlocking elements include an engaging hook formed on said engaging end portion of said pressing plate, and an engaging groove formed on said base plate.

4. The eyeglass auxiliary device of claim 1, wherein said temple-connecting unit includes a hook for anchoring on the temple of the eyeglass device.

5. The eyeglass auxiliary device of claim 1, wherein said clamp unit further includes a coupling plate having a first end hinged to said second side of said base plate and a second end opposite to said first end and formed with a pin-extension hole, and an engaging pin projecting from said second side of said base plate to interlock with said pin-extension hole, said engaging pin including a leg portion connected to said base plate and a barbed end connected to said leg portion oppositely of said base plate.

6. The eyeglass auxiliary device of claim 5, wherein said temple-connecting unit includes a connecting body formed with a first through hole adapted to receive the temple of the eyeglass device, and a second through hole, said coupling plate extending into said second through hole such that said pin-extension hole is exposed from said connecting body.

7. The eyeglass auxiliary device of claim 5, wherein said leg portion includes a shoulder part proximate to said base plate.

8. The eyeglass auxiliary device of claim 5, wherein said clamp portion of said pressing plate cooperates with said base plate to define a clamp space that includes a wide space portion adjacent to said engaging end portion and a narrow space portion adjacent to said wide space portion.
